(19) United States
(12) Patent Application Publication
(10) Pub. No.: US 2017/0350585 A1
(43) Pub. Date: Dec. 7, 2017

(54) Illuminating Glove

(71) Applicant: Harold Jose Salazar David, Katy, TX (US)

(72) Inventor: Harold Jose Salazar David, Katy, TX (US)

(21) Appl. No.: 15/175,838

(22) Filed: Jun. 7, 2016

(51) Int. Cl. F21V 33/00; F21V 23/00; A41D 19/015; F21V 23/04; A41D 19/00; F21L 4/00; H05B 33/08; F21V 31/00; F21W 131/30

(52) U.S. Cl. CPC F21V 33/0008; H05B 33/0845; F21V 23/003; A41D 19/0157; F21V 31/00; F21V 23/04; A41D 19/002; F21L 4/00; A41D 2400/22; F21W 2131/30

(57) ABSTRACT

An illuminating glove for provision of light proximate to a hand of a user includes a shell that is hand shaped and flexible. The shell comprises a set of five tubes. An opening is positioned in the shell such that the shell is configured to receive a hand of a user inserted through the opening singly positioning the fingers and thumb of the hand into respective tubes. A power module, a plurality of lights and a controller are coupled to the shell. The controller is operationally coupled to the power module and to each of the plurality of lights. The controller is positioned to selectively couple the lights to the power module, such that the lights are configured to illuminate a space proximate to the shell.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to gloves and more particularly pertains to a new glove for provision of light proximate to a hand of a user.

### BRIEF SUMMARY OF THE INVENTION

An embodiment of the disclosure meets the needs presented above by generally comprising a shell that is hand shaped and flexible. The shell comprises a set of five tubes. An opening is positioned in the shell such that the shell is configured to receive a hand of a user inserted through the opening singly positioning the fingers and thumb of the hand into respective tubes. A power module, a plurality of lights and a controller are coupled to the shell. The controller is operationally coupled to the power module and to each of the plurality of lights. The controller is positioned to selectively couple the lights to the power module, such that the lights are configured to illuminate a space proximate to the shell.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an illuminating glove according to an embodiment of the disclosure.

FIG. 2 is a back view of an embodiment of the disclosure.

FIG. 3 is an in-use view of an embodiment of the disclosure.

FIG. 4 is a detail view of an embodiment of the disclosure.

FIG. 5 is a cross-sectional view of an embodiment of the disclosure.

### DETAILED DESCRIPTION OF THE INVENTION

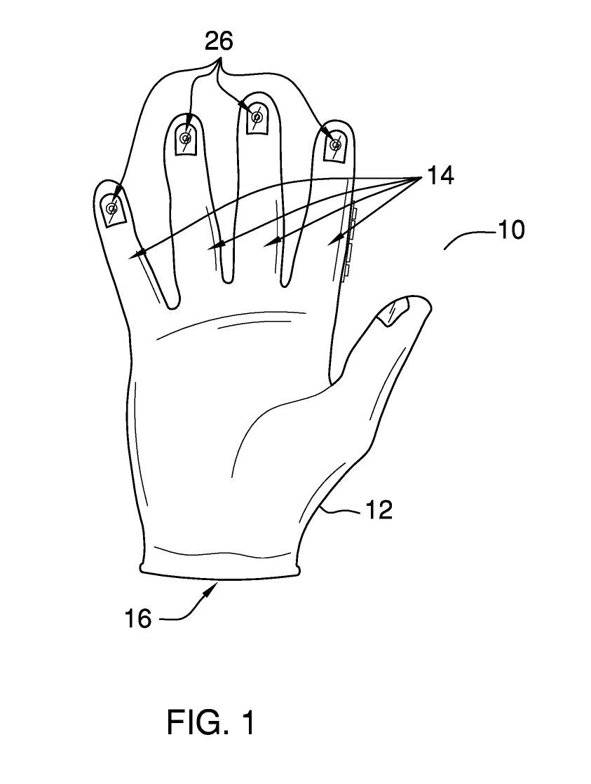

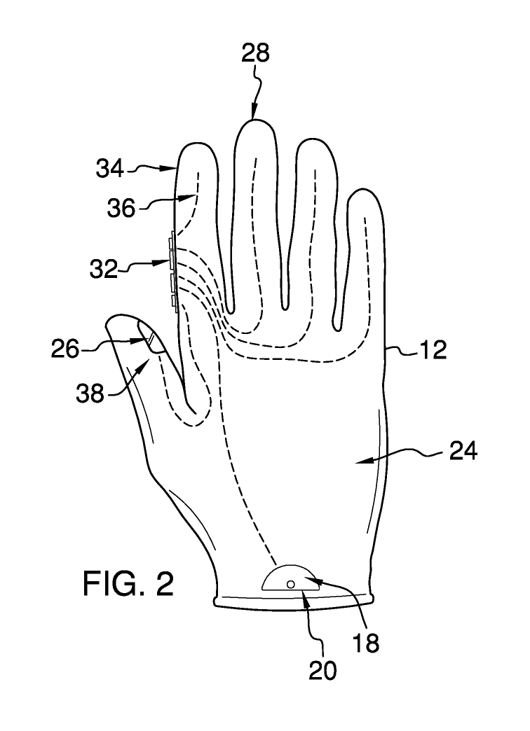

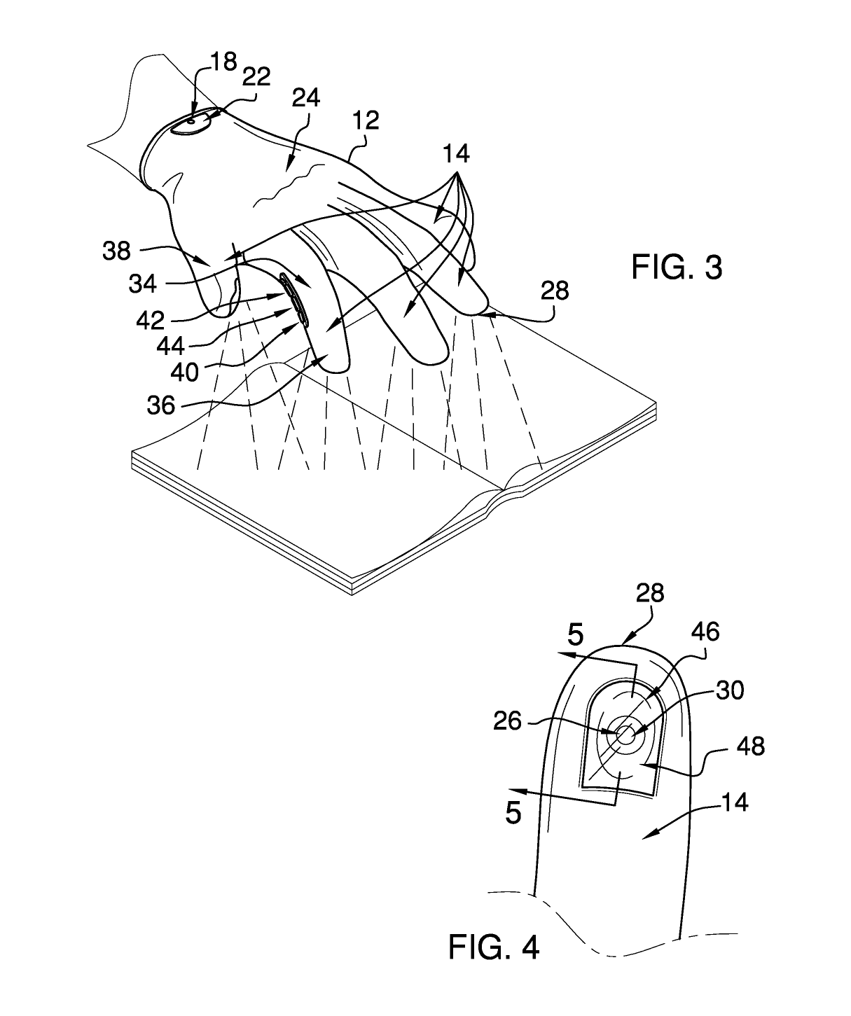

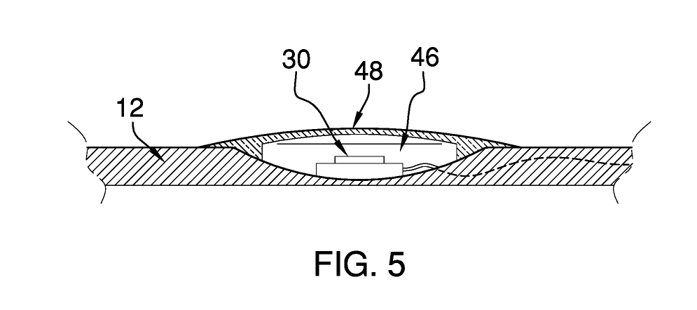

With reference now to the drawings, and in particular to FIGS. 1 through 5 thereof, a new glove embodying the principles and concepts of an embodiment of the disclosure and generally designated by the reference numeral 10 will be described.

As best illustrated in FIGS. 1 through 5, the illuminating glove 10 generally comprises a shell 12 that is hand shaped and flexible. The shell 12 comprises a set of five tubes 14. The shell 12 comprises fabric. In one embodiment, the fabric is breathable. An opening 16 is positioned in the shell 12. The opening 16 is positioned in the shell 12 such that the shell 12 is configured to receive a hand of a user inserted through the opening 16 to singly position the fingers and thumb of the hand into respective tubes 14. In one embodiment, the shell 12 is configured for insertion of the user's right hand. In another embodiment, the shell 12 is configured for insertion of the user's left hand.

A power module 18 is coupled to the shell 12. The power module 18 comprises at least one battery 20. In one embodiment, the at least one battery 20 is rechargeable. The power module 18 is positioned within a compartment 22 coupled to the shell 12. The compartment 22 is coupled to the shell 12 proximate to the opening 16. The compartment 22 is coupled to the shell 12 on a back 24 of the shell 12.

A plurality of lights 26 is coupled to the shell 12. In one embodiment, the plurality of lights 26 comprises lights 26 coupled singly proximate to a tip 28 of each tube 14. In another embodiment, the lights 26 comprise light emitting diodes 30.

A controller 32 is coupled to the shell 12. The controller 32 is operationally coupled to the power module 18 and to each of the plurality of lights 26. The controller 32 is positioned to selectively couple the lights 26 to the power module 18, such that the lights 26 are configured illuminate a space proximate to the shell 12. The controller 32 is coupled to a side 34 of an index tube 36. The controller 32 is positioned on the index tube 36 such that the controller 32 is configured for operation by action of a thumb of the user when the thumb is inserted into a thumb tube 38 of the shell 12.

In one embodiment, the controller 32 comprises an On/Off button 40. The On/Off button 40 is positioned on the index tube 36 such that the On/Off button 40 is configured to turn the plurality of lights 26 on and to turn the plurality of lights 26 off. In another embodiment, the controller 32 comprises a brightness button 42. The brightness button 42 is positioned on the index tube 36 such that the brightness button 42 is configured to control the degree of illumination provided by the plurality of lights 26. In yet another embodiment, the controller 32 comprises a plurality of selectors 44. The selectors 44 are positioned on the index tube 36 such that the selectors 44 are configured to selectively operate each of the plurality of lights 26.

A plurality of pockets 46 is coupled to the shell 12. The lights 26 are singly coupled to the shell 12 within each pocket 46. Each pocket 46 has an outer face 48 that is substantially transparent. The outer face 48 is positioned on the pocket 46 such that a respective light 26 coupled to the shell 12 within the pocket 46 is configured to illuminate a space proximate to the pocket 46.

In one embodiment of the invention, the compartment 22, the controller 32 and the pocket 46 are water tight, such that the shell 12 is washable.

In use, the opening 16 is positioned in the shell 12 such that the shell 12 is configured to receive a hand of a user inserted through the opening 16, singly positioning the fingers and thumb of the hand into respective tubes 14. The controller 32 is positioned on the index tube 36 such that the controller 32 is configured for operation by action of a thumb of the user when the thumb is inserted into a thumb tube 38 of the shell 12. The controller 32 is positioned to selectively couple the lights 26 to the power module 18, such that the lights 26 are configured to illuminate a space proximate to the shell 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminating glove comprising:
a shell, said shell being hand shaped, said shell being flexible, said shell comprising a set of five tubes;
an opening positioned in said shell, said opening being positioned in said shell such that said shell is configured to receive a hand of a user inserted through said opening singly positioning the fingers and thumb of the hand into respective said tubes;
a power module coupled to said shell;
a plurality of lights coupled to said shell;
a controller coupled to said shell, said controller being operationally coupled to said power module and each of said plurality of lights, wherein said controller is positioned to selectively couple said lights to said power module, such that said lights are configured illuminate a space proximate to said shell; and
wherein said opening being positioned in said shell such that said shell is configured to receive a hand of a user inserted through said opening singly positioning the fingers and thumb of the hand into respective said tubes, wherein said controller is positioned to selectively couple said lights to said power module, such that said lights are configured illuminate a space proximate to said shell.

2. The glove of claim 1, further including said shell comprising fabric.

3. The glove of claim 2, further including said fabric being breathable.

4. The glove of claim 1, further including said shell being configured for insertion of a user's right hand.

5. The glove of claim 1, further including said shell being configured for insertion of the user's left hand.

6. The glove of claim 1, further including said power module comprising at least one battery, said at least one battery being rechargeable.

7. The glove of claim 1, further including said power module being positioned within a compartment coupled to said shell, said compartment being coupled to said shell proximate to said opening, said compartment being coupled to said shell on a back of said shell.

8. The glove of claim 1, further including said plurality of lights comprising lights coupled singly proximate to a tip of each said tube.

9. The glove of claim 1, further including said lights comprising light emitting diodes.

10. The glove of claim 7, further including said controller being coupled to a side of an index tube, wherein said controller is positioned on said index tube such that said controller is configured for operation by action of a thumb of the user when the thumb is inserted into a thumb tube of said shell.

11. The glove of claim 10, further including said controller comprising an On/Off button, wherein said On/Off button is positioned on said index tube such that said On/Off button is configured to turn said plurality of lights on and to turn said plurality of lights off.

12. The glove of claim 10, further including said controller comprising a brightness button, wherein said brightness button is positioned on said index tube such that said brightness button is configured to control the degree of illumination provided by said plurality of lights.

13. The glove of claim 10, further including said controller comprising a plurality of selectors, wherein said selectors are positioned on said index tube such that said selectors are configured to selectively operate each of said plurality of lights.

14. The glove of claim 10, further including a plurality of pockets coupled to said shell, said lights being singly coupled to said shell within each said pocket, each said pocket having an outer face, said outer face being substantially transparent, wherein said outer face is positioned on said pocket such that a respective said light coupled to said shell within said pocket is configured to illuminate a space proximate to said pocket.

15. The glove of claim 14, further including said compartment, said controller and said pockets being water tight, such that said shell is washable.

16. An illuminating glove comprising:
a shell, said shell being hand shaped, said shell being flexible, said shell comprising a set of five tubes, said shell comprising fabric, said fabric being breathable;
an opening positioned in said shell, said opening being positioned in said shell such that said shell is configured to receive a hand of a user inserted through said opening singly positioning the fingers and thumb of the hand into respective said tubes, said shell being configured for insertion of a user's right hand, said shell being configured for insertion of the user's left hand;
a power module coupled to said shell, said power module comprising at least one battery, said at least one battery being rechargeable, said power module being positioned within a compartment coupled to said shell, said compartment being coupled to said shell proximate to said opening, said compartment being coupled to said shell on a back of said shell, said compartment being water tight;
a plurality of lights coupled to said shell, said plurality of lights comprising lights coupled singly proximate to a tip of each said tube, said lights comprising light emitting diodes;
a controller coupled to said shell, said controller being operationally coupled to said power module and each of said plurality of lights, wherein said controller is positioned to selectively couple said lights to said power module, such that said lights are configured illuminate a space proximate to said shell, said controller being coupled to a side of an index tube, wherein said controller is positioned on said index tube such that said controller is configured for operation by action of a thumb of the user when the thumb is inserted into a thumb tube of said shell, said controller comprising an On/Off button, wherein said On/Off button is positioned on said index tube such that said On/Off button is configured to turn said plurality of lights on and to turn said plurality of lights off, said controller comprising a brightness button, wherein said brightness button is positioned on said index tube such that said brightness button is configured to control the degree of illumination provided by said plurality of lights, said controller comprising a plurality of selectors, wherein said selectors are positioned on said index tube such that said selectors are configured to selectively operate each of said plurality of lights, said controller being water tight;
a plurality of pockets coupled to said shell, said lights being singly coupled to said shell within each said pocket, each said pocket having an outer face, said outer face being substantially transparent, wherein said outer face is positioned on said pocket such that a respective said light coupled to said shell within said pocket is configured to illuminate a space proximate to said pocket, said pockets being water tight; and
wherein said opening being positioned in said shell such that said shell is configured to receive a hand of a user inserted through said opening singly positioning the fingers and thumb of the hand into respective said tubes, wherein said controller is positioned to selectively couple said lights to said power module, such that said lights are configured illuminate a space proximate to said shell.
